(19) United States
(12) Patent Application Publication
(10) Pub. No.: US 2026/0043510 A1
(43) Pub. Date: Feb. 12, 2026

(54) PLUG HEAD RETENTION CONFIGURATION

(71) Applicant: CALDERA ENGINEERING, L.C., Provo, UT (US)

(72) Inventors: Jeffrey C. Robison, Provo, UT (US); Joey Bateman, Provo, UT (US); Chauncy Ripple, Provo, UT (US); Janus Van Dam, Provo, UT (US)

(73) Assignee: CALDERA ENGINEERING, L.C., Provo, UT (US)

(21) Appl. No.: 19/292,152

(22) Filed: Aug. 6, 2025

Related U.S. Application Data
(60) Provisional application No. 63/680,362, filed on Aug. 7, 2024.

(51) Int. Cl. F16L 55/11

(52) U.S. Cl. CPC F16L 55/11

(57) ABSTRACT

A plug head assembly is provided including a plug stem base comprising an interior volume, a plug head at least partially surrounded by a collet, and the plug head disposed at least partially within the plug stem base.

### CROSS-REFERENCE TO RELATED APPLICATIONS

This application claims priority to, and the benefit of, U.S. Provisional Patent Application No. 63/680,362, filed Aug. 7, 2024 and titled “PLUG HEAD RETENTION CONFIGURATION,” which is incorporated by reference herein in its entirety for all purposes.

### BACKGROUND

In various industrial processes, such as in mineral processing, solids and liquids may be conveyed from one vessel to another under high temperatures and high pressures. Plug heads are used to provide fluidic sealing and/or flow control

### SUMMARY

In various embodiments, a plug assembly is provided comprising a plug stem base comprising an interior volume, a plug head at least partially surrounded by a collet, the plug head disposed at least partially within the plug stem base.

In various embodiments, a method of forming a plug head assembly is provided comprising disposing a collet circumferentially about a plug head, contacting a proximal end of the plug head to a proximal end of an interior volume of a plug stem base.

### BRIEF DESCRIPTION OF THE DRAWINGS

Various embodiments are particularly pointed out and distinctly claimed in the concluding portion of the specification. Below is a summary of the drawing figures, wherein like numerals denote like elements and wherein:

FIG. 1 illustrates an ore processing system in accordance with various embodiments;

FIG. 2 illustrates a plug head in accordance with various embodiments;

FIG. 3 illustrates the plug head of FIG. 2 in an exploded view, in accordance with various embodiments;

FIG. 4 illustrates a cross section view of a plug stem base in accordance with various embodiments;

FIG. 5 illustrates a plug head, in accordance with various embodiments;

FIG. 6 illustrates a plug head in an exploded view, in accordance with various embodiments;

FIG. 7 illustrates a collet in an isometric view, in accordance with various embodiments; and

FIG. 8 illustrates an assembled plug assembly, in accordance with various embodiments.

### DETAILED DESCRIPTION

The detailed description of exemplary embodiments herein makes reference to the accompanying drawings, which show exemplary embodiments by way of illustration and its best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

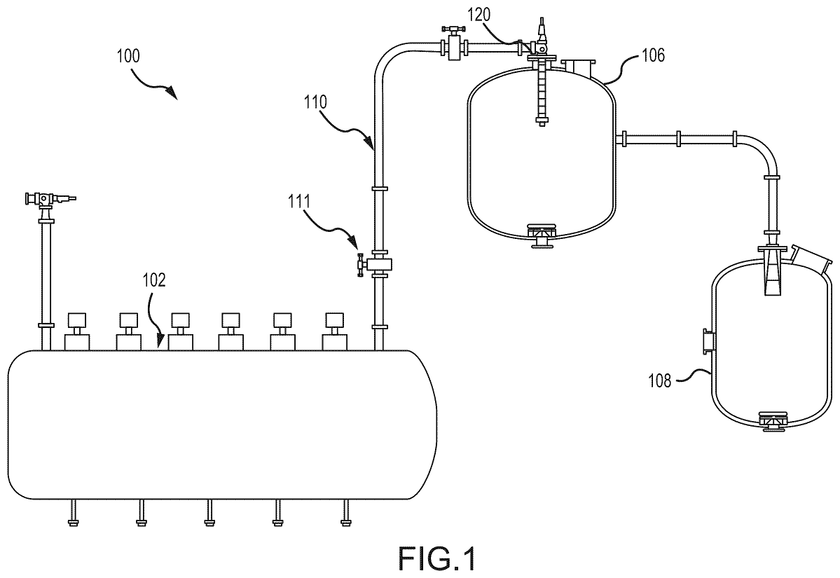

A throttling or control valve may operate to regulate the flow of a fluid or slurry in a conduit. For example, with reference to FIG. 1, ore processing system 100 is illustrated. Ore processing system 100 may be used in connection with high pressure acid leaching (“HPAL”), pressure oxidation (“POX”) or any other mining or industrial applications where a solvent is mixed with material containing one or more metals and subjected, for example, to at least one of elevated temperatures or pressures.

A mixture of solids, liquids, and/or gasses may be referred to as slurry, may be subjected to high temperatures and/or high pressures in autoclave 102. For example, ore may be mixed with strong acids (e.g. H₂SO₄) or strong bases (e.g., NaOH or NH₃) and may be subjected to temperatures of from 80° C. to 300° C. or greater and total pressures of from about 10 psi (˜68 kPa) to 900 psi (˜6,205 kPa). The slurry may have a pH below 1 to 4 (in an acidic application) or between about 10 to 14 (in a basic application). A throttling valve, such as a control valve 120, may be positioned between autoclave 102 and a flash tank 106, and may act to control the flow between the two components of ore processing system 100. Low pressure flash tank 108 is also illustrated for reference. Control valve 120 may be paired with isolation valve 111. Isolation valve 111 may be a ball valve, plug valve, or any other suitable valve.

Autoclave 102 may be sized according to industrial need, but is in various embodiments greater than 200 m³. The size of discharge line 110 may also vary, but is in various embodiments greater than 50 mm in diameter. Control valve 120 may comprise an angle-type valve.

In other embodiments, control valve 120 can comprise a non-isolation valve, wherein control valve 120 is used to reduce or regulate pressure and/or flow. For example, control valve 120 can comprise a flash letdown valve, or a level control valve, among other types of valves.

In operation, control valve 120 may be actuated to a closed position to fluidly isolate flash tank 106 from autoclave 102. In response to actuation to an open position, control valve 120 may experience slurry flow at high velocities, temperatures and pressures as slurry flows from autoclave 102 to flash tank 106. Control valve 120 may thus experience corrosive and erosive conditions, combined with flow velocities approaching or exceeding the speed of sound, for the fluid at process conditions, for extended periods of time.

The intended material flowing past a plug head assembly and through a valve seat assembly, and the velocities at which such material is intended to flow, is important in valve design. In various embodiments, a slurry comprising a solid phase, liquid phase, and gas phase is intended to flow past a plug head and into a valve seat assembly. According to compressible flow theory and the thermodynamics of a multiphase system, the flow at the throat is choked and flowing at the local speed of sound, according to various embodiments. As the area expands, the velocity increases and the fluid density decreases.

Plug heads are often made from ceramic materials that are resistant to corrosion and erosion. However, ceramic plug heads are often mounted into assemblies containing metal parts. Given the differences in coefficients of thermal expansion between ceramic and metals, it may be challenging to mount a ceramic plug head in a metal housing using fasteners or other conventional devices such as bolts or screws. Without proper fitting techniques, under operating temperatures as described herein, metallic components may expand to a greater extent than the ceramic components, causing the ceramic components to come loose or free of the metal components. Moreover, fasteners add to part count and may take longer to install and adjust to the desired fit.

Accordingly, more robust solutions to retain ceramic plug heads are desired. Disclosed herein, in various embodiments, are plug head arrangements that include a collet and/or specialized geometries that act to retain ceramic plug heads.

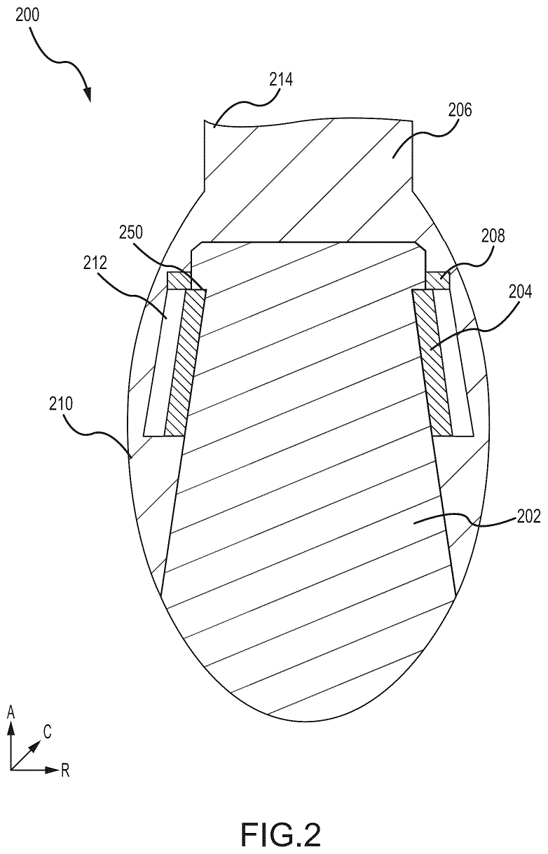

With reference to FIG. 2, plug head assembly 200 is shown in cross section. Axial-Radial-Circumferential (A-R-C) axes are shown for convenience in this and other Figures. It should be noted that a first component shown displaced in a positive axial direction with respect to second component may be referred to as distal to the second component. Plug assembly 200 may be used in a variety of valve configurations.

Plug assembly 200 comprises plug stem base 206, plug head 202, stem 214, and spacer 208.

In various embodiments, the plug head assembly 200 may comprise a plug head 202 that comprises a ceramic material. Ceramics are especially well suited to high erosion applications. The plug head may have a varying geometry. For example, the exposed portion of the plug head 202 geometry may be spherical, parabolic, flat, or any other suitable geometric configuration. Plug head 202 as illustrated has a parabolic geometry, characterized by the parabolic surface that interacts with a valve seat. However, in various embodiments, plug head 202 has a flat distal surface. There may further be a translating shaft coupled to plug stem base 206. In various embodiments, the plug head 202 can comprise one or more metals, such as, for example, various steel alloys, stainless steel, titanium, ceramics such as silicon carbide (SiC), boron carbide (B₄C), tungsten carbide (WC), and zirconia (ZrO₂), and nickel chromium alloys, such as an austenitic nickel-chromium alloy such as the austenitic nickel-chromium alloy sold under the trademark INCONEL. Nickel chromium alloys may be well suited to high temperature environments. Moreover, plug stem base 206 may comprise any suitable metal alloy, including various steel alloys, stainless steel, titanium, titanium alloys, and nickel chromium alloys, such as an austenitic nickel-chromium alloy such as the austenitic nickel-chromium alloy sold under the trademark INCONEL.

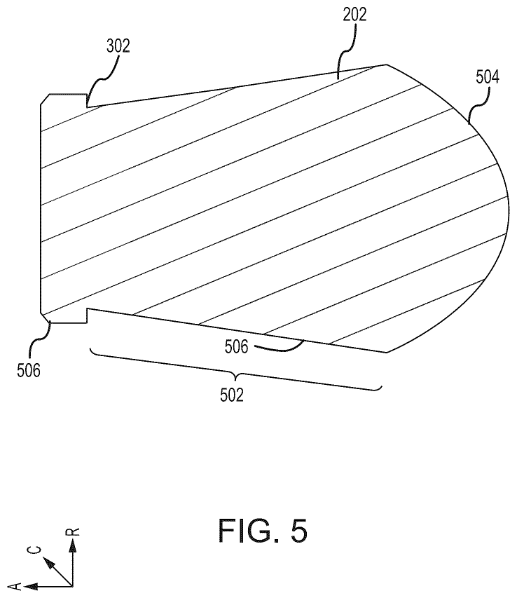

With reference to FIG. 5, plug head 202 is shown alone. Parabolic face 504 of plug head 202 is configured to engage with a valve seat to provide fluidic flow control. Plug head 202 comprises frustoconical portion 506. In this regard, plug head 202 widens in the distal (negative A) direction. Plug head 202 also comprises shoulder 302. Shoulder 302 is an area of increased cross sectional diameter relative to frustoconical portion 506. Shoulder 302 may increase in cross sectional diameter in a proximal (positive A) direction relative to parabolic face 504, for example in a step wise manner as shown in FIG. 5. In that manner, shoulder 302 provides a distal (positive A direction) facing surface.

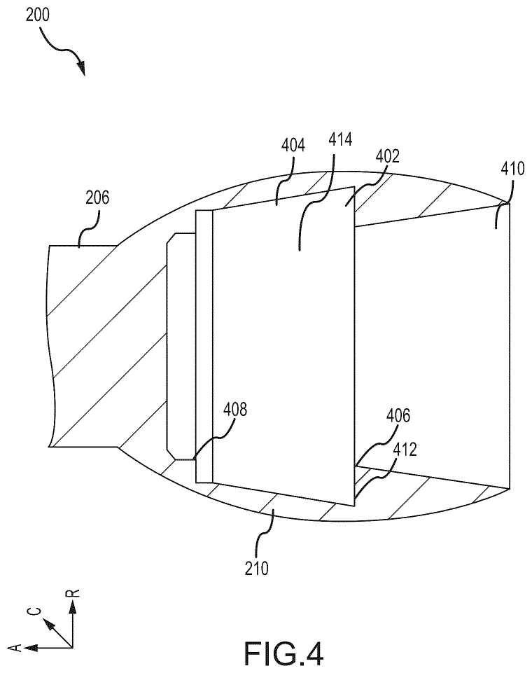

With reference to FIG. 4, plug stem base 206 is illustrated according to various embodiments.

Plug stem base 206 includes distal extension 210 that is configured to at least partially surround plug head 202. The interior of plug stem base 206 may be formed with various internal features that may act to retain plug head 202 within or substantially within plug stem base 206 in interior volume 414. However, plug stem base 206 may be formed by any suitable means, including casting, forging, milling, electrical discharge machining (EDM), turning, or any other suitable means. In various embodiments, plug stem base 206 is 3D printed.

Various features may be formed in plug stem base 206 to mate with various surfaces of plug head 202. For example, proximal frustoconical portion 404 comprises a frustoconical interior portion of plug stem base 206. Proximal frustoconical portion 404 abuts distal frustoconical portion 410. Distal frustoconical portion 410 is distal (displaced in negative A direction relative) to proximal frustoconical portion 404. Distal frustoconical portion 410 has a widest cross sectional diameter at the distal terminus of plug stem base 206. Distal frustoconical portion 410 meets proximal frustoconical portion 404 at interface 406. Interface 406 represents a change in cross sectional diameter from the widest (largest cross sectional diameter) portion of proximal frustoconical portion 404 to the narrowest (smallest cross sectional diameter) of distal frustoconical portion 410. In this regard, interface 406 comprises an abrupt change in cross sectional diameter of plug stem base 206 to and thus forms a mating face 412 that circumscribes all or substantially all the interior circumference of plug stem base 206.

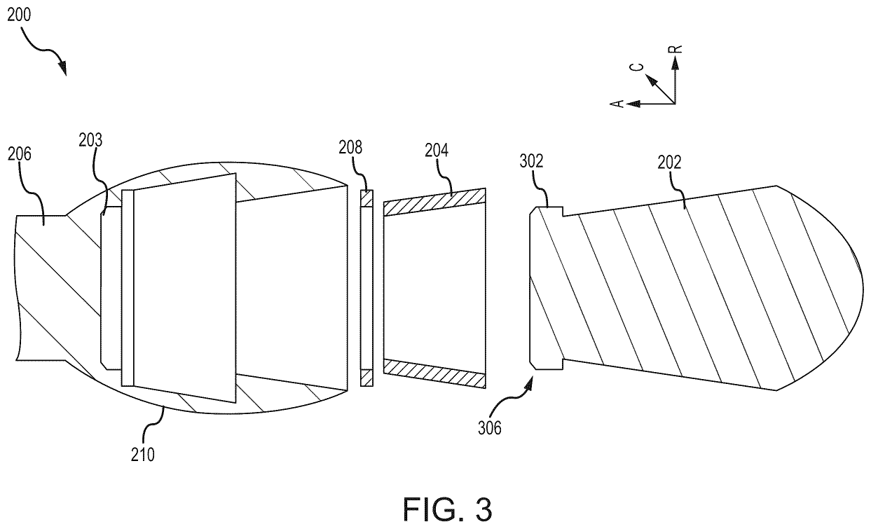

With reference to FIGS. 2, 3, and 4, the plug assembly 200 is shown in both assembled and exploded views. Plug head 202 is illustrated as inserted into plug stem base 206 in FIG. 2. In this manner, the distal portion of plug head 202, namely a portion of frustoconical portion 506, is contacted by and engaged by distal frustoconical portion 410 of plug stem base 206. Thus, distal frustoconical portion 410 of plug stem base 206 at partially contacts the distal portion of plug head 202.

Collet 204 comprises a collet that is generally frustoconical in shape and generally conforming to a portion of frustoconical portion 506 of plug head 202. Collet may comprise any suitable metal alloy and non metals, including various steel alloys, stainless steel, titanium, titanium alloys, and nickel chromium alloys, such as an austenitic nickel-chromium alloy such as the austenitic nickel-chromium alloy sold under the trademark INCONEL, polytetrafluoroethylene (PTFE), filled PTFE, thermoplastics and thermosets. Collet 204 may be a generally solid structure, though in various embodiments, collet 204 comprises one or more slots or cutouts in the axial direction that allow for flexibility in the radial direction.

The collet 204 may be interference fit onto plug head 202. In various embodiments, where collet 204 comprises axial slots or cut outs, collet 204 may be mechanically expanded to fit about frustoconical portion 506 of plug head 202. Releasing the mechanical force allows the collet 204 to spring back to conform to frustoconical portion 506 of plug head 202. Collet 204 may be translated proximally towards shoulder 302 of plug head 202 and contact shoulder 302 to act to stop proximal translational movement with respect to plug head 202.

Collet travel limiting spacer 208 may comprise an annular ring structure. Collet travel limiting spacer 208 may comprise any suitable metal alloy, including various steel alloys, stainless steel, titanium, titanium alloys, and nickel chromium alloys, such as an austenitic nickel-chromium alloy such as the austenitic nickel-chromium alloy sold under the trademark INCONEL. However, collet travel limiting spacer 208 may also comprise rubber, silicone, synthetic rubbers, polytetrafluoroethylene (PTFE), glass filled PTFE, expanded PTFE, and other similar materials.

Collet travel limiting spacer 208 acts to stabilize collet 204 within plug stem base 206. Collet travel limiting spacer 208 may be placed within plug stem base 206, translating collet travel limiting spacer 208 in a proximal direction until collet travel limiting spacer 208 contacts mating face 408 of plug stem base 206. Mating face 408 of plug stem base 206 comprises a surface made by reducing the inner diameter of the plug stem base 206. In this manner, mating face 408 faces in a distal direction and acts to stop proximal translation of the collet travel limiting spacer 208 with respect to plug stem base 206.

To assemble, plug head assembly 200, collet travel limiting spacer 208 is placed within plug stem base 206 and translated in a proximal direction until collet travel limiting spacer 208 contacts mating face 408 of plug stem base 206. Collet 204 may be inserted into plug stem base 206 followed by plug head 202. In various embodiments, however, plug head 202 with collet 204 disposed on frustoconical portion 506 of plug head 202 is inserted into the plug stem base 206.

Plug head 202 may be inserted into plug stem base 206 until plug head 202 contacts surface 203. In this manner, plug head 202 at least partially is disposed within proximal frustoconical portion 404. Surface 203 represents the most proximal interior portion of plug stem base 206. In this manner, surface 203 helps to retain plug head 202 within plug stem base 206 by, for example, resisting axial impact forces. Collet pocket 212 within proximal frustoconical portion 404 of plug stem base 206 allows for expansion and contraction of collet 204 in response to plug head 202 being inserted into 206 and various temperatures experienced across operating conditions. Moreover, collet 204 may contact mating face 412 of plug stem base 206. Mating face 412 is a proximal facing surface of plug stem base 206 that acts to retain collet 204 within plug stem base 206. For example, in various embodiments, contact between collet 204 and plug head 202 at circumferential interface 250 creates a mechanical load path through the interface of collet 204 and mating face 412 of plug stem base 206. In this manner, once plug head 202 is inserted into plug stem base 206, the contact between collet 204 and mating face 412 may render removal of plug head 202 from plug stem base 206 difficult or impossible. Moreover, as assembled, collet 204 is disposed within proximal frustoconical portion 404 while only plug head 202 is disposed within distal frustoconical portion 410. Moreover, plug head 202 may be disposed so as to occupy all or substantially all of distal frustoconical portion 410.

Collet travel limiting spacer 208 circumferentially surrounds plug head 202, contacting a portion of plug head 202, radially outward of plug head 202, collet travel limiting spacer 208 circumferentially contacts plug stem base 206. The coefficient of thermal expansion (“CTE”) of collet travel limiting spacer 208 may be selected such that, in response to elevated temperatures, collet travel limiting spacer 208 may expand at a greater rate than plug head 202 and/or plug stem base 206. In this manner, collet travel limiting spacer 208 may expand in volume at a faster rate than plug stem base 206 expands in response to elevated temperatures, assisting in retention. Since plug head 202, which is comprised of a ceramic material, has a relatively low CTE and plug stem base 206 comprises a metal or metal alloy, which has a higher CTE than plug head 202, it is beneficial to have collet travel limiting spacer 208 comprise a material having a CTE higher than both plug stem base 206 and plug head 202. In various embodiments, however, plug stem base 202 has the same or similar CTE than collet travel limiting spacer 208. For reference, fine ceramics can range in coefficients of thermal expansion from approximately 2*10⁻⁶ mm/mm/° C. to approximately 11*10⁻⁶ mm/mm/° C. while INCONEL alloys can range in coefficients of thermal expansion from approximately 13*10⁻⁶ mm/mm/° C. to approximately 16*¹⁰⁻⁶ mm/mm/° C.

Plug head assembly 200 thus provides, in various embodiments, a system that is able to retain a ceramic plug head in a metallic plug stem base without use of fasteners such as bolts, screws, or clamps that maintains an ability to retain plug head 202 in response to elevated operating temperatures. This structure reduces the weight of plug head assembly 200 in comparison to traditional structures, as well as reduces material and manufacturing parts and lowers part count. Moreover, plug head assembly 200, in various embodiments, provides for a smaller overall package size (i.e., lower volume of plug head 202) as well as more erosion resistant geometries. In addition, the collet design may allow for a plug head that can be manufactured to lower tolerances, reducing costs while maintaining desired performance characteristics.

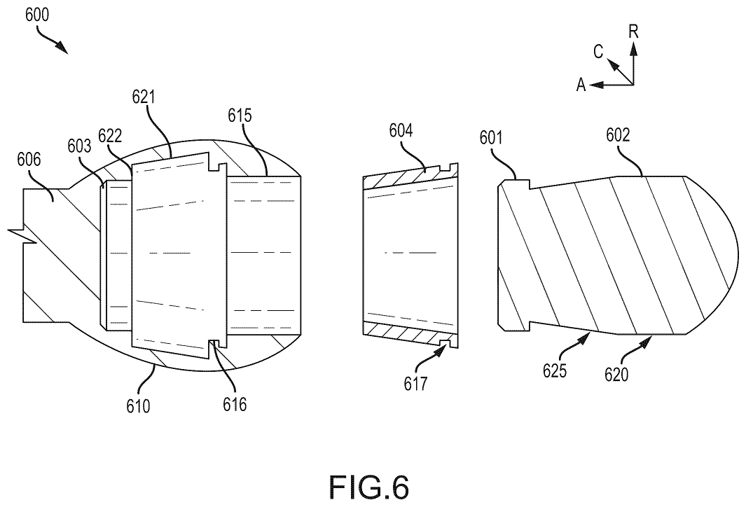

With reference to FIG. 6, the plug assembly 600 is shown in an exploded view. Plug head 602 is illustrated as configured for insertion into plug stem base 606. In this manner, a distal portion of plug head 602, namely cylindrical portion 620, is contacted by and engaged by distal cylindrical portion 615 of plug stem base 606. Thus, distal cylindrical portion 620 of plug head 602 at partially contacts cylindrical portion 620.

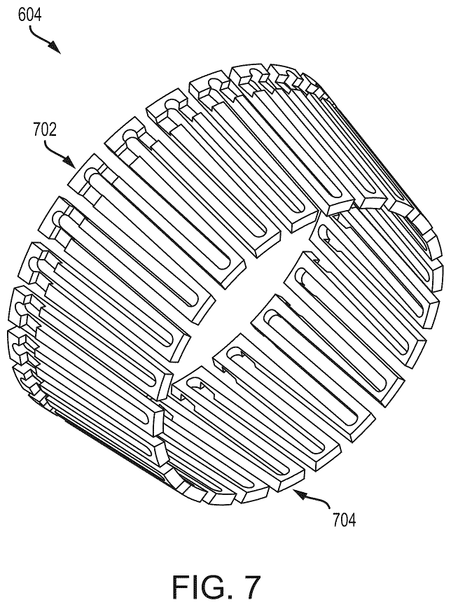

Collet 604 comprises a collet that is generally frustoconical in shape and generally conforming to a portion of frustoconical portion 621 of plug stem base 606. However, in various embodiments, collet 604 is cylindrical in shape, which in such embodiments, frustoconical portion 621 would also be cylindrical. Collet 604 may comprise any suitable metal alloy and non metals, including various steel alloys, stainless steel, titanium, titanium alloys, and nickel chromium alloys, such as an austenitic nickel-chromium alloy such as the austenitic nickel-chromium alloy sold under the trademark INCONEL, polytetrafluoroethylene (PTFE), filled PTFE, thermoplastics and thermosets. Collet 604 may be a generally solid structure, though in various embodiments, collet 604 comprises one or more slots or cutouts in the axial direction that allow for flexibility in the radial direction. As illustrated, with momentary reference to FIG. 7, collet 604 is shown as a serpentine collet. In this manner, collet 604 may comprise alternate peaks 702 and 704 and axial cutouts, allowing collet 604 to flex radially.

The collet 604 may be mechanically contracted to fit within frustoconical portion 621 of plug head 602. Releasing the mechanical force that causes collet 604 to contract allows the collet 604 to spring back to be able to conform to frustoconical portion 621 of plug head 602. Collet 604 may be translated proximally towards surface 603 of plug stem base 606 and contact surface 603 to act to stop proximal translational movement with respect to plug stem base 606.

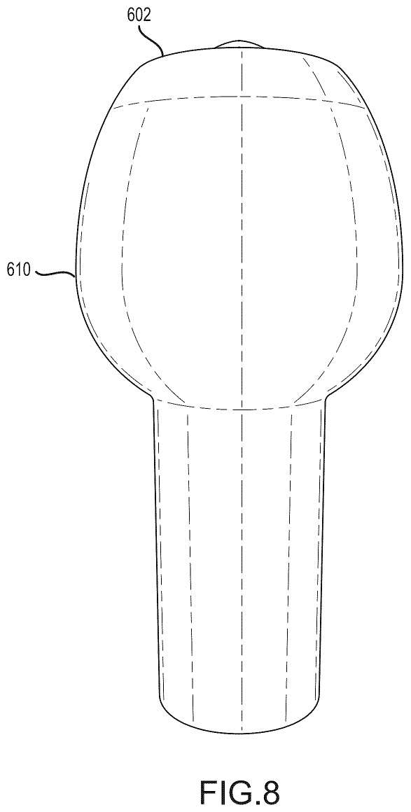

In various embodiments, to assemble plug assembly 200, collet 604 may be inserted into plug stem base 606. Translating collet 604 proximally into plug stem base 606 causes collet 604 to stop at stop surface 622. Radial cutout 617 of collet 604 may interface with and seat within radial protrusion 616 (also referred to as collet retaining step) of plug stem base 606. The interface between radial cutout 617 and radial protrusion 616 provides axial retention of collet 604 within plug stem base 606. Then, the plug head 602 is inserted into the plug stem base 606. During insertion, collet 604 at least partially surrounds plug head 602 and acts to retain plug head 602 in plug stem base 606. An assembled plug assembly 200 is shown in FIG. 8.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A plug assembly comprising:
a plug stem base comprising an interior volume;
a plug head at least partially surrounded by a collet, the plug head disposed at least partially within the plug stem base.

2. The plug assembly of claim 1, wherein the plug stem base comprises a proximal frustoconical portion and a distal frustoconical portion.

3. The plug assembly of claim 2, wherein the proximal frustoconical portion of plug stem base circumscribes the collet and wherein the collet is entirely within the proximal frustoconical portion of plug stem base.

4. The plug assembly of claim 3, wherein a proximal surface of the collet contacts the plug head at a circumferential interface, wherein a distal surface of the collet contacts the plug stem base at a proximally facing surface.

5. The plug assembly of claim 4, further comprising a collet travel limiting spacer.

6. The plug assembly of claim 5, wherein the collet travel limiting spacer circumscribes the plug head.

7. The plug assembly of claim 6, wherein the collet travel limiting spacer contacts a surface of the interior volume.

8. The plug assembly of claim 7, wherein the interior volume comprises a collet pocket.

9. The plug assembly of claim 8, wherein a portion of the plug head extends beyond the interior volume, wherein the plug head comprises a parabolic surface.

10. The plug assembly of claim 9, wherein the collet comprises at least one of a slot or cutout.

11. The plug assembly of claim 10, wherein the proximal surface of the collet contacts the collet travel limiting spacer.

12. The plug assembly of claim 11, wherein the plug head comprises a ceramic material.

13. The plug assembly of claim 12, wherein the collet comprises at least one of a metal or metal alloy.

14. The plug assembly of claim 13, wherein the collet travel limiting spacer comprises at least one of rubber, silicone, synthetic rubbers, polytetrafluoroethylene (PTFE), glass filled PTFE, expanded PTFE, and other similar materials.

15. The plug assembly of claim 14, wherein the collet travel limiting spacer has a coefficient of thermal expansion greater than both the plug stem base and the plug head.

16. The plug assembly of claim 15, wherein the plug head occupies the entirety of the distal frustoconical portion.

17. The plug assembly of claim 16, wherein the plug stem base comprises at least one of a steel alloy, stainless steel, titanium, titanium alloys, or nickel chromium alloys.

18. A method of forming a plug assembly comprising:
disposing a collet circumferentially about a plug head;
contacting a proximal end of the plug head to a proximal end of an interior volume of a plug stem base.

19. The method of claim 18, further comprising disposing a collet travel limiting spacer circumferentially around the plug head.

20. The method of claim 19, wherein the disposing the collet comprises mechanically stretching the collet.
